(19) United States
(12) Patent Application Publication
(10) Pub. No.: US 2008/0315017 A1
(43) Pub. Date: Dec. 25, 2008

(54) Nozzle With Impinging Jets

(75) Inventors: Anders E. Jensen, Allerod (DK); Christian Boe, Farum (DK); Niels Torp Madsen, Birkerod (DK)

Correspondence Address: KNOBBE MARTENS OLSON & BEAR LLP, 2040 MAIN STREET, FOURTEENTH FLOOR, IRVINE, CA, 92614, US

(73) Assignee: Grundfos NoNox A/S, Beerringbro (DK)

(21) Appl. No.: 12/097,386

(22) PCT Filed: Dec. 15, 2006
(86) PCT No.: PCT/DK2006/050074

§ 371 Date: Aug. 29, 2008

(30) Foreign Application Priority Data
Dec. 16, 2005 (DK) PA 2005 01783
Nov. 16, 2006 (DK) PA 2006 01505

(51) Int. Cl. B05B 7/12; F01N 3/00; B05B 1/00

(52) U.S. Cl. 239/408; 60/276; 239/8

(57) ABSTRACT

The present invention relates to a nozzle for atomization of one or more fluids by letting two streams of fluid impinge. In a nozzle according to the invention the fluid is divided in a number of streams each given kinetic energy. The amount of kinetic energy given to streams is so that when the streams impinge at conditions where substantial opposite directed velocity components of the streams exist the streams will break up into a spray having a small droplet size.

### CROSS REFERENCE TO RELATED APPLICATIONS

This application is a national phase application of and claims the benefit of priority to PCT/DK/2006/050074, filed Dec. 15, 2006, which designated the United States and was published in English and claims the benefit of priority to Danish Patent Application Nos. PA 200501783, filed on Dec. 16, 2005 and PA 200601505, filed on Nov. 16, 2006. The disclosures of all of the aforementioned applications are hereby expressly incorporated by reference in their entirety.

In this invention a nozzle for atomization of one or more fluids is assembled from a number of different elements, which can be combined in a variety of custom-made embodiments in order to suit specific needs. Thereby the invention also addresses a number of solutions to different aspects while still pertaining to the same inventive concept.

The present invention relates to a nozzle for atomization of one or more fluids by letting two streams of fluid impinge. In a nozzle according to the invention the fluid is divided in a number of streams each given kinetic energy. The amount of kinetic energy given to streams is so that when the streams impinge at conditions where substantial opposite directed velocity components of the streams exist the streams will break up into a spray having a small droplet size. This is in the present context referred to as atomizing. It is essential to the atomizing process that each stream of fluid “hits” each other centrally, e.g. that the two streams of fluid is within the plane, if one aims at providing a best possible atomization. Furthermore, a balance between the streams' mass flow and velocity should be present to provide a spray that is not lopsided.

A first object of the present invention is to provide a nozzle for atomization of one or more fluids offering a better control in terms of precision and timing of the impinging fluids.

The invention also relates to rinsing of the nozzle according to the invention by increasing the fluid pressure to a level higher than the normal working pressure. The fluid is preferably purified or filtered before the atomization process so that no impurities are carried with the fluid itself to the nozzle. However, if the nozzle should begin to clog up due to deposit of impurities present in the surroundings, e.g. by formation of crystals, it is possible to perform a cleansing or rinsing procedure of the nozzle according to the invention by increasing the pressure of the pressurized fluid. The pressure increase may simply force the impurity through and out of the nozzle or it may cause the fluid to overflow the impurity and the area closest thereto. Thereby the fluid stream may also sweep or draw away any impurity or the overflowing may cause the fluid to dissolve the impurity into the fluid flow leading to the cleaning or rinsing of the nozzle. Hence, the selfrinsing procedure is a dynamic function resulting from possible pressure increase, which does not occur when the nozzle is working under normal conditions.

Therefore, another object of the invention is to provide a nozzle with an improved reliability and being able to perform a self-rinsing procedure.

Thus, in a first aspect the invention relates to a nozzle comprising a first member having a surface A and a fluid inlet and a fluid outlet, two or more channels formed in or between the surface A and a surface B of a second member at least when the nozzle is pressurised, and a second member overlying the first member.

The nozzle has a first member with a surface A. The first member also has a fluid inlet and a fluid outlet. Two or more channels may be provided in the surface A of the first member for guiding a flow of fluid. The fluid inlet preferably consists of one inlet opening and preferably it has a conduit in connection therewith for leading the fluid to the fluid outlet, however, depending on requirements, any number of openings and/or conduits may be provided. The fluid outlet is in fluid communication with the two or more channels and may also consist of any number and shape of openings. The first member may have any kind of peripheral shape but is preferably rectangular. The nozzle also has a second member with a surface B overlying the first member. The shape of the second member preferably substantially corresponds to that of the first member. All the elements of the nozzle may of course also have a custom shaped profile e.g. for retrofitting it into existing devices.

It is very important in regard of the fluid guiding that the two fluid streams “hit” each other in exactly the same plane in order to achieve the best atomization. The streams are directed in the (x,y)-directions (see FIG. 3) by the configuration of the two or more channels. In order to be able to precisely control the fluid streams in the (z)-direction, it is essential that the surfaces A and B of the first and second elements are highly stiff/rigid and substantially planar.

In a particular embodiment the channels are at least two converging and open channels being in fluid communication with the fluid outlet and facilitating equal velocity and volume flow of each fluid stream at the channel openings.

When the nozzle is provided with two or more channels it is very important that these converge and are otherwise so constructed that they facilitate an equal velocity and volume flow of each fluid stream at the channel openings. This may e.g. be provided if the channels are of exactly the same length and positioned in a strict symmetrical relationship around and/or in connection with the outlet of the first member. It is the accuracy of the flow velocity and the volume of the fluid streams “delivered” at the channel openings for impinging with each other as well as the correct timing that are the essentials for creating the optimal atomization. Therefore, it is also possible to provide channels which differ in shape and size as long as the before-mentioned criteria are met. It is furthermore essential to the nozzle design according to the invention that all surfaces of the channels and/or of the surrounding areas are sharp i.e. having distinct edges at substantially right angles in order to gain the necessary control of the flow of the fluid streams. Thereby positioning and timing of the impinging of the fluid streams is further optimized, which in turn yields a correct and optimized atomization of the fluid streams. However, if these criteria are not fulfilled it is not possible to make the fluid streams impinge in exactly the same plane e.g. at a distance from the nozzle leading to a bad performance of the nozzle.

The first and second members may preferably consist of a solid and durable material such as metal, plastic or ceramics. The first and second members may have a thickness exceeding that of the other members of the nozzle. Apart from the possible two or more channels in surface A of the first member, the surface may be substantially uninterrupted.

Other surfaces of the first and second members, as well as any other members or elements of the nozzle, may have any preferred profile and/or shape.

In its simplest form the nozzle consists of the first and second members with the two or more channels provided in surface A. By applying pressure to the flow of fluid in this embodiment of the nozzle the fluid streams will flow through the openings of the channels in the side surface of the first member and impinge at e.g. a distance from the side of the nozzle as previously indicated.

In another preferred embodiment the two or more channels for the fluid are provided in a channel spacer positioned between the surface A of the first member and the surface B of the second member. In this embodiment the surfaces A and B of the first and second members may preferably be substantially uninterrupted and planar. The channel spacer may preferably be an individual sheet membrane of any suitable material such as metal, plastic, resin, fabric, ceramic or any combination thereof.

In a preferred embodiment the nozzle further comprises a resilient member positioned between the surfaces A and B of the first and second members.

A resilient member may be provided between the first and the second members of the nozzle. In a particular embodiment the two or more channels of the nozzle may be provided in surface A of the first member while one or more indentations may be provided in surface B of the second member. By applying pressure to the fluid flow the resilient member can be moved a distance away from the surface A thus guiding the fluid between the surface A of the first member and the surface of the resilient member since the one or more indentations in the second member allow(s) space for the resilient member as it is moved by the pressure. Thereby the nozzle can atomize a fluid even though no channels are provided in the resilient member. The resilient member may preferably be an individual sheet membrane of any suitable material such as metal, plastic, resin, fabric or other materials having a suitable resiliency, or any combination thereof.

In yet another preferred embodiment the nozzle further comprises a retention sheet member placed between the resilient member and the second member. The retention sheet member may preferably be another individual sheet membrane or layer of any suitable material, such as metal, plastic, resin, fabric, ceramic or any combination thereof. The retention sheet member may have an uninterrupted surface or it may be provided with one or more cut-outs depending on e.g. the performance characteristics such as volume flow and speed and/or preciseness of the nozzle or on the needed pressure for overflowing in regard to the cleaning procedure. By providing the retention sheet member with cut-outs, pressure of a certain magnitude will force the resilient member towards the retention sheet member which may in turn be engaged by the fluid force and thereby allow passage of the fluid. The retention sheet member may also be pre-stressed by providing it with a tension e.g. by bending the part defined by the cut-outs to engagement with the surface of the resilient member when assembling the nozzle. By applying this solution it is possible to control the movement of the resilient member because a fluid pressure of a certain magnitude will be necessary to overcome the pretension of the retention sheet. The amount of fluid delivered, and ultimately the accuracy of the atomization, is thereby to some degree controllable.

In the embodiments of the invention one or more indentations that can have any suitable shape and size may be provided in the surface B of the second member and/or in an indentation member. The indentation(s) is/are provided in order to give way for lifting of the retention sheet member and/or the resilient member by the fluid pressure. The indentation(s) may have any suitable shape and size. The indentation member may preferably also consist of any suitable material, such as metal, plastic, resin, fabric, ceramic or any combination thereof.

The different elements of the nozzle may preferably also have one or more holes for housing one or more guides intended to control the positioning of the elements in correct, aligned relationship. The holes and the guides may have any suitable shape but are preferably circular. The elements preferably also have one or more holes for housing one or more suitable retaining means such as screws in order to be able to assemble the elements of the nozzle construction in a firm and tight manner.

In preferred embodiments of the invention, the at least two channels may be arranged so that fluid streams flowing through the channel impinge one another outside the nozzle. Alternatively, or in combination thereto the at least two channels may preferably be arranged as channels intersecting inside the nozzle, at and/or above an end surface of the nozzle so that fluid streams flowing through the channels impinge one another at and/or above the end surface or at least partly inside the nozzle. The channels are preferably converging channels.

In preferred embodiments of the invention, the channels may preferably be arranged so that fluid streams discharged from at least two channels impinge each other at an angle of between 30 and 100°.

Typically and preferably, the cross sectional area of each of the fluid streams discharged from the channels may preferably be in the range of 0.003 to 0.15 mm², preferably in the range of 0.005 to 0.05 mm², such as in the range of 0.01 to 0.03 mm², preferably 0.02 mm².

In a second aspect the invention relates to a nozzle system for atomizing one or more fluids comprising two or more of the nozzles according to the first aspect of the invention.

According to the second aspect, any number and/or configuration of individual nozzles comprising some or all of the elements mentioned above may be “put together”, e.g. to increase volume flow or for letting streams of fluid impinge e.g. at larger distances from the side of the nozzle. In other situations it may be desirable to be able to adjust the behaviour of the atomized spray or “cloud” by alternating the angle between two or more fluid streams. The system may also be configured so as to act as an overpressure valve openable if and when necessary thus creating improved dynamic flexibility.

In a third aspect the invention relates to an exhaust system for a combustion engine, the system comprises a nozzle and/or nozzle system according to the present invention.

In a fourth aspect the invention relates to a method of atomizing fluid, preferably being liquefied urea, the method utilising the nozzle and/or nozzle system according to the present invention.

The many possible configurations according to the first and second aspects of the invention allow for a highly specified and custom-shaped solution. A particular advantageous and easy controlling of the geometry of the nozzle is obtained, which allows for a precise and correctly timed delivery of a needed volume of fluid.

### BRIEF DESCRIPTION OF THE DRAWINGS

FIG. 1 is a perspective view of the nozzle with first and second members and showing the one or more channels in the surface A of the first member.

FIG. 2 is a perspective view of the nozzle with first and second members and with a channel spacer positioned there between.

FIG. 3 is a perspective view of the nozzle with first and second members and a resilient member positioned there between and showing the one or more channels in the surface A of the first member and an indentation in surface B of the second member.

FIG. 4 is a perspective view of the nozzle with first and second members and with both a channel spacer and a resilient member positioned there between.

FIG. 5 is a perspective view of the nozzle with first and second members with both a channel spacer and a resilient member and a retention sheet member positioned between the first and second members with an indentation in surface B of the second member.

FIG. 6 is a perspective view of the nozzle corresponding to that of FIG. 5 comprising a separate indentation member.

FIG. 7 is a perspective view of the nozzle with no channels but with an indentation in surface B of the second member.

FIG. 8 is a perspective view of the nozzle illustrating in more detail how nozzle elements are guided and assembled.

FIG. 9 is a schematic view of a nozzle system according to the second aspect of the invention comprising two channel spacers and a combination member.

FIG. 10 is a schematic view of a nozzle assembly wherein the channels are provided in all members of the assembly.

FIGS. 11 and 12 are schematic views of channel spacers according to the present invention. FIG. 11b and 12b respectively is a close-up view of the channel spacer shown in FIG. 11a and 12a with details of the flow pattern indicated.

FIGS. 13 and 14 are schematic views channels spacers according to the present invention.

### DETAILED DESCRIPTION OF THE PREFERRED EMBODIMENTS

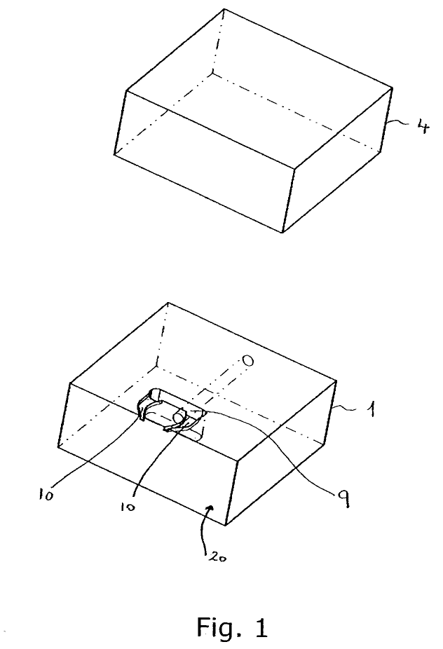

FIG. 1 is a perspective view of an embodiment of the invention in which the channels (10) for guiding the fluid flow are provided in the first member (1). The channels (10) extend partly through the first member (1) and are in fluid communication with the fluid outlet (9) of the first member. The channels (10) are open meaning that their converging openings terminate in surface (20) of the first member (1). Surface (20) is shown substantially planar but can also comprise one or more indentations of any suitable shape, e.g. crescent-shape. In this embodiment the fluid atomizes when the two fluid streams flowing through the channels (10) impinge at a distance from the openings of the channels.

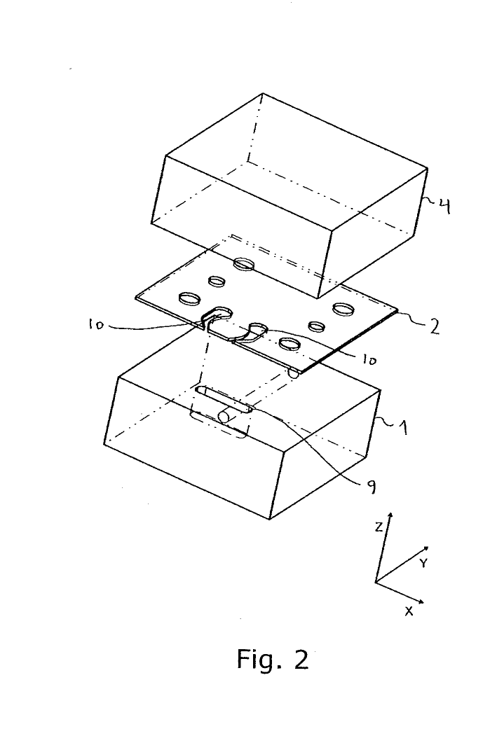

FIG. 2 is a perspective view of an embodiment wherein a channel spacer (2) is provided between the first (1) and the second (4) members. The channel spacer (2) is provided with channels (10) for guiding the fluid flow. The channels (10) extend partly or wholly (which is shown) through the channel spacer (2) and are in fluid communication with the fluid outlet (9) of the first member (1). The channels (10) are open and their converging openings terminate in a side of the channel spacer (2). The other surfaces of the members (1, 2, 4) are shown substantially planar.

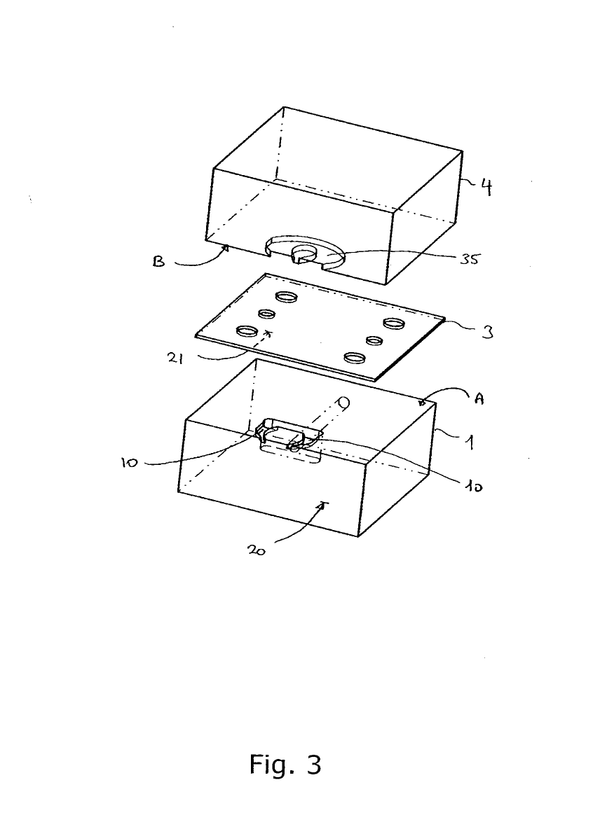

FIG. 3 is a perspective view of another embodiment of the invention in which a resilient member (3) is positioned between the first (1) and the second members (4) and wherein the channels (10) for guiding the fluid flow are provided in the first member (1). The channels (10) extend partly through the first member (1) and are in fluid communication with a fluid outlet of the first member. The channels (10) are open and their converging openings terminate in surface (20) of the first member (1). Surface (20) is shown substantially planar but can also comprise one or more indentations of any suitable shape, e.g. crescent-shape. The surface B of the second member (4) is shown provided with an indentation (35) giving space for the resilient member (3) when needed. The main surfaces of the resilient (3) member are shown substantially planar.

In this embodiment the fluid atomizes when the two fluid streams flowing through the channels (10) impinge at a distance from the openings of the channels achieved at normal working pressure. If the nozzle channels should clog up due to deposit of impurities present in the surroundings, it is possible to perform a cleansing or rinsing procedure with the present embodiment by increasing the pressure of the pressurized fluid to an elevated pressure higher than the normal working pressure. By way of such elevated pressure the resilient member (3) will be forced away from the channels (10) of the first member (1) into the space of the indentation (35) in the second member (4), thereby allowing the fluid to overflow the impurity between surface A of the first member and surface (21) of the resilient member. This overflowing of the impurity and the area closest thereto causes the fluid stream to sweep or draw away any impurity, thereby cleaning or rinsing the nozzle. Subsequently, when the pressure returns to the normal working pressure the nozzle will resume atomizing the fluid at normal rate and precision. Beside from performing a rinsing of the nozzle elements such an increase in pressure may also be provided to increase the volume flow of the nozzle if necessary.

In the case that an unintentional clogging of the nozzle elements occurs despite a regular maintenance procedure (e.g. performing a pressure increase at predetermined time intervals) the pressure may build up by itself due to reduced passage possibility. This may cause the fluid to begin overflowing the impurities and/or the adjacent surfaces of the elements and thereby remove the clogging subject. Once the impurities are removed the pressure will drop to its normal level again.

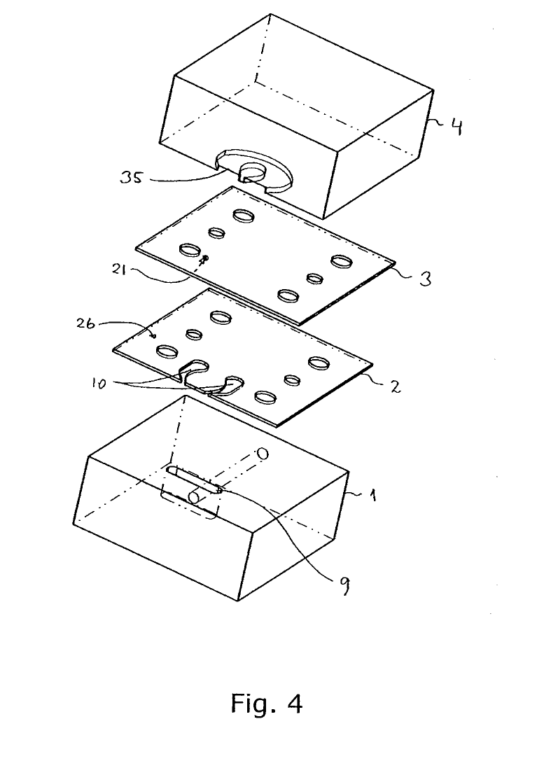

FIG. 4 is a perspective view of another embodiment of the invention in which a channel spacer (2) is provided between the first member (1) and a resilient member (3). The channel spacer (2) is provided with the channels (10) for guiding the fluid flow. The surfaces of the individual elements are shown substantially planar. The channels (10) in the channel spacer (2) extend partly or wholly through the channel spacer (2) and are in fluid communication with the fluid outlet (9) of the first member (1). The channels (10) are open and their converging ends terminate in a side of the channel spacer.

The fluid atomizes when the two fluid streams flowing through the channels (10) are pressurized and impinge at a distance from the openings of the channels. In similar manners as described with respect to the embodiment of FIG. 3, a cleaning procedure or volume increase can be performed by increasing the pressure to an elevated pressure above normal working pressure. This will cause the resilient member (3) to be forced away from the channel spacer (2) into the space of the indentation (35) in the second member (4), thereby allowing the fluid to overflow impurities between the surface (26) of the channel spacer (2) and the surface (21) of the resilient member (3) thereby cleaning or rinsing the channels as mentioned above and/or increasing the volume flow.

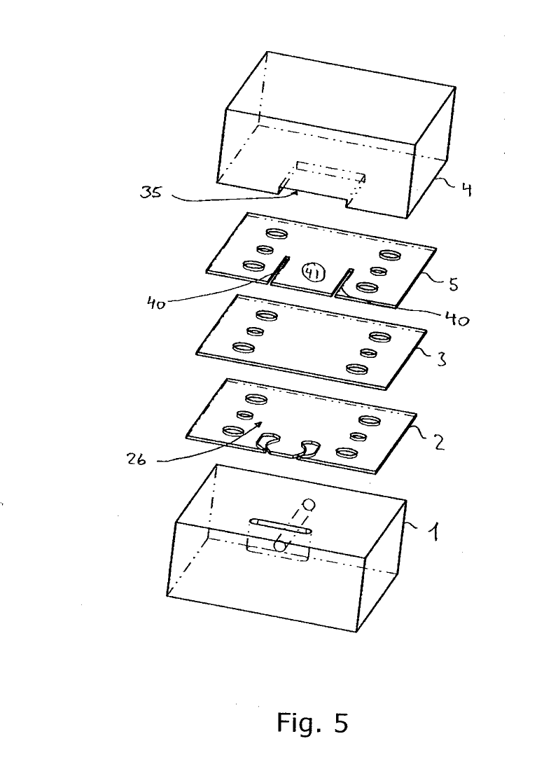

FIG. 5 is a perspective view of still another embodiment of the invention similar to the one shown in FIG. 4 except that it further has a retention sheet member (5) between the resilient member (3) and the second member (4). In the figure the retention sheet member (5) has two through-going notches (40) terminating in open ends at the side 35 of the retention sheet member (5). The part (41) of the retention sheet member (5) between the two notches (40) is joined to the rest of the retention sheet (5) along a line running between the two notches.

In the figure the second member (4) has an indentation (35) in its surface B. The indentation (35) is provided to give room for the part (41) of the retention sheet member (5). This allows for the part (41) to be forced away from the resilient member (3) when an increased pressure is applied to the fluid flow. If the pressure is increased to an elevated pressure above the normal working pressure the fluid will start to overflow the channels (10) and the surrounding area of the surface (26) of the channel spacer (2), which in turn forces the resilient member (3) to move away from the channel spacer (2) thereby exerting a force on the part (41) of the retention sheet member (5) causing it to at least bend along the line between the notches and move into the space of indentation (35) of the second member (4).

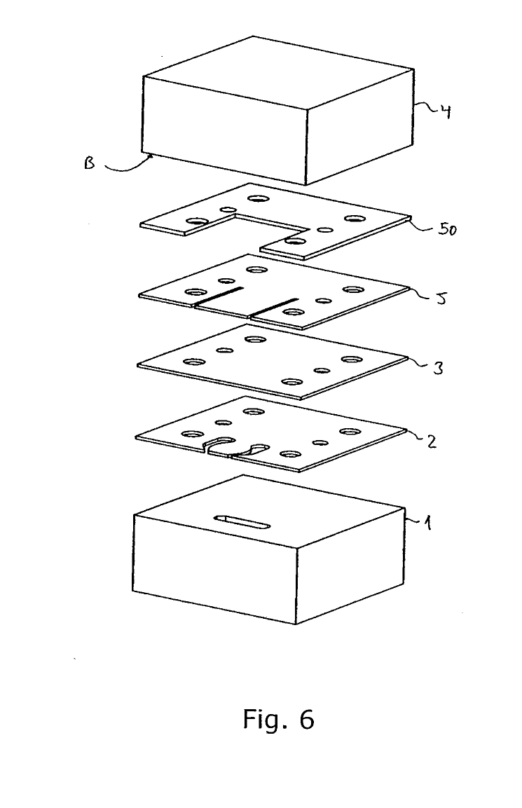

FIG. 6 corresponds to the embodiment shown in FIG. 5 except that it comprises a separate indentation member (50) instead of providing the surface B of the second member (4) with an indentation.

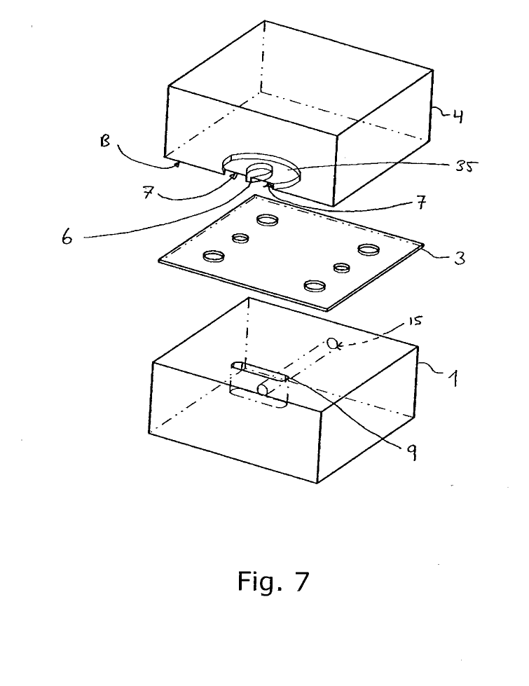

FIG. 7 is a perspective view of an embodiment of a nozzle wherein the first member (1) is provided with an outlet for the fluid (9) being in communication with the fluid inlet (15) through a conduit and the second member (4) has an indentation (35) in the surface B. When the fluid is pressurized, the resilient member (3) will be forced away from the outlet (9) of the first member thereby forming channels for fluid flow substantially corresponding to the shape of the outlet (9) and/or the indentation (35). In the figure the indentation (35) is crescent shaped with two converging and open ends (7). The crescent shaped indentation (35) surrounds a plateau (6), the surface of which is level with the rest of surface B. This embodiment allows for an increased volume of fluid flow but may not provide the same degree of the accuracy for atomization as the other described embodiments.

In FIG. 7, the fluid atomizes when the pressurized fluid streams flow through the channels formed by the shape of the outlet (9) and the indentation (35) and impinge at a distance from the open ends (7). In similar manners as described with respect to other embodiments the pressure can be increased to an elevated pressure above normal working pressure in order to e.g. rinse the nozzle. This will cause the resilient member (3) to be forced away from the surface A thereby allowing the fluid to overflow the surface, which in turn facilitates not only the possible rinsing of the nozzle, but also an increase in the volume of the fluid flow. Subsequently, when the pressure is lowered again to the normal working pressure, the nozzle will resume atomizing the fluid at the normal rate. When no pressure at all is applied to the fluid, the resilient member (3) prevents any contamination of the nozzle due to impurities from the nozzle's surroundings by effectively closing off the outlet (9).

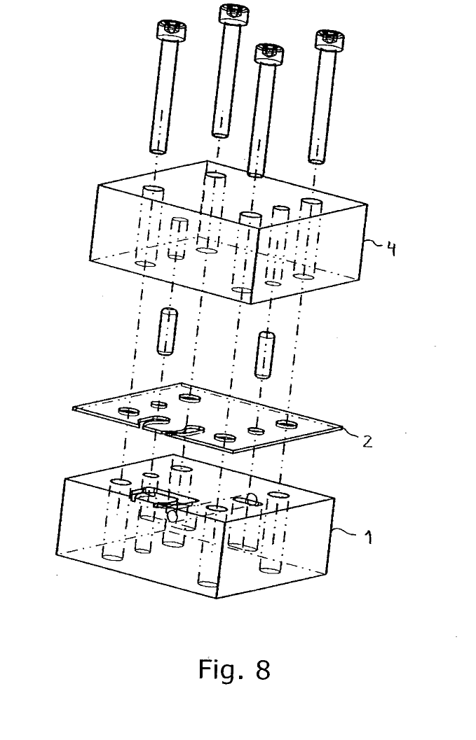

FIG. 8 is a perspective view of a way in which the nozzle elements may be assembled in order to provide a tight and duly sealed nozzle construction. The different elements of the nozzle has one or more holes for housing one or more guides for controlling of the positioning of the elements in correct, aligned relationship. The holes and the guides can have any suitable shape but are shown circular. The nozzle elements also have one or more holes for housing retaining means, in the figure shown as screws. Thereby the elements of the nozzle can be assembled in a firm and tight manner.

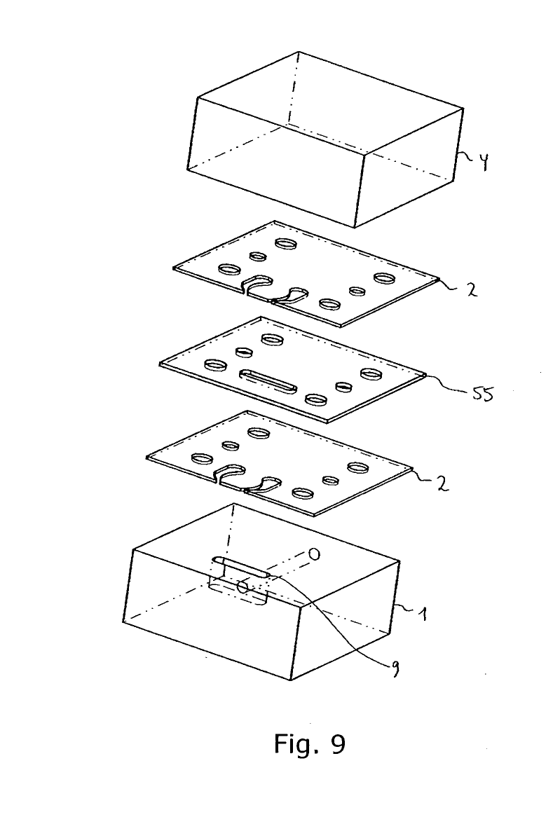

FIG. 9 shows a schematic view of a nozzle system in which two channel spacers according to the first aspect of the invention are provided with a combination element. Such a nozzle system may comprise one or more combination elements (55) that may be “shared” between e.g. the first and second members of the nozzle. In such a combination element a fluid inlet, conduit and outlet may be provided which leads fluid to more than one fluid atomization, i.e. being divided into two “branches” or it may comprise a sheet with a fluid guide opening provided between e.g. two channel spacers. The fluid guide opening can correspond to the shape of the outlet (9) of the first member. The nozzle system facilitates the provision of more than two impinging fluid streams and is thus able to provide an alternative atomization of the fluid. A number of individual nozzle assemblies can also be provided adjacent to each other for establishing a nozzle system (not shown).

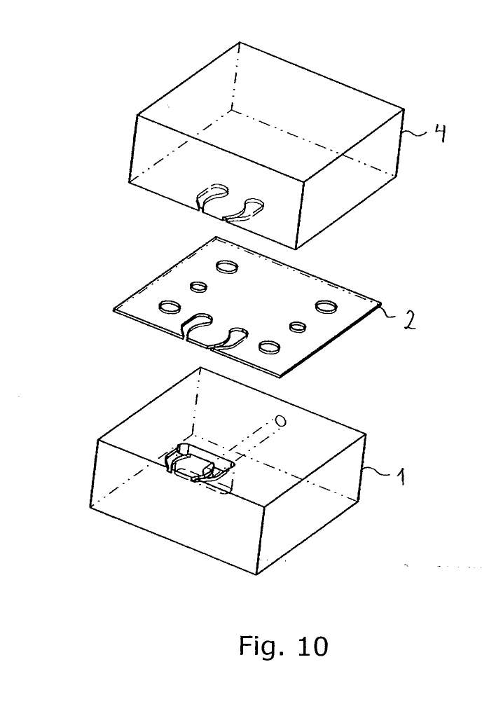

FIG. 10 shows a schematic view of a nozzle in which all of the nozzle parts are provided with two channels for guiding the fluid flow. The first (1) and second (4) members as well as channel spacer (2) are shown with two channels. However, the channels can also be provided in only one of the first and second members and in the channel spacer or in both the first and second members without using a channel spacer.

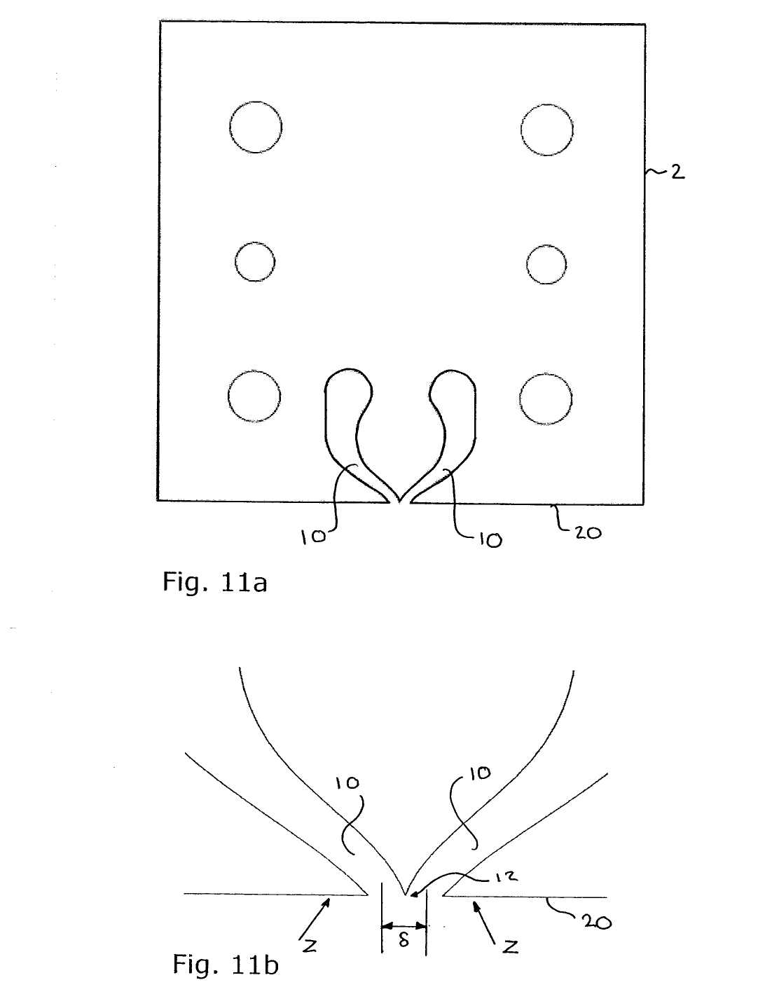

FIG. 11a and 11b shows a schematic view of channel spacer (2) similar to the one shown in FIG. 2. The channel spacer (2) is designed so that the two fluid streams flowing through the channels (10) impinge closer to the openings of channels (10). This is provided by decreasing the distance 5 between the openings of the channels (10) when compared to e.g. the embodiment shown in FIG. 1. In the embodiment shown in FIG. 11, the distance 5 has been decreased so much that openings are situated in close proximity to each other and only divided by an edge-shaped wall end (12) and is provided by arranging the flow channels (10) as two channels intersecting at the level of end surface (20) of the channel spacer (2)—and thereby the level of the nozzle—as shown in FIG. 11a and 11b.

The embodiment of FIG. 11 is particular useful in case atomization results in a spray of droplets in a direction towards and/or sideways of the nozzle, i.e. when back spray occur. Such a back spray may in some configurations of the channels (10) result in depositing of material on the nozzle, which material may clog the openings of the channels (10). In the embodiment shown in FIG. 11, the two openings of the channels (10) are arranged in the spacer (2) so that the two streams of fluid impinge substantially at the openings of the channels (10) and if back spray would occur depositing would only occur on the end surface (20) and out side of the nozzle as indicated in FIG. 11a and 11b by arrows marked Z. If back spray results in droplets travelling into the openings of the channels (10) these channels are kept wet by the fluid flowing through them resulting in that such droplets will be absorbed by the fluid. It is found that only little back spray occurs with the embodiment shown in FIG. 11.

A further advantage is present in the embodiments where the two channels (10) intersect. In these embodiments, the streams flowing out of the channels (10) will always impinge at least to some extend irrespective of whether the two channels (10) extend in a common plane, and production of the channels and thereby the nozzle is in general easier than in the embodiments where the two channels does not intersects as such embodiments requires that the two channels extend substantially in a common plane so as to assure impingement of the fluid streams.

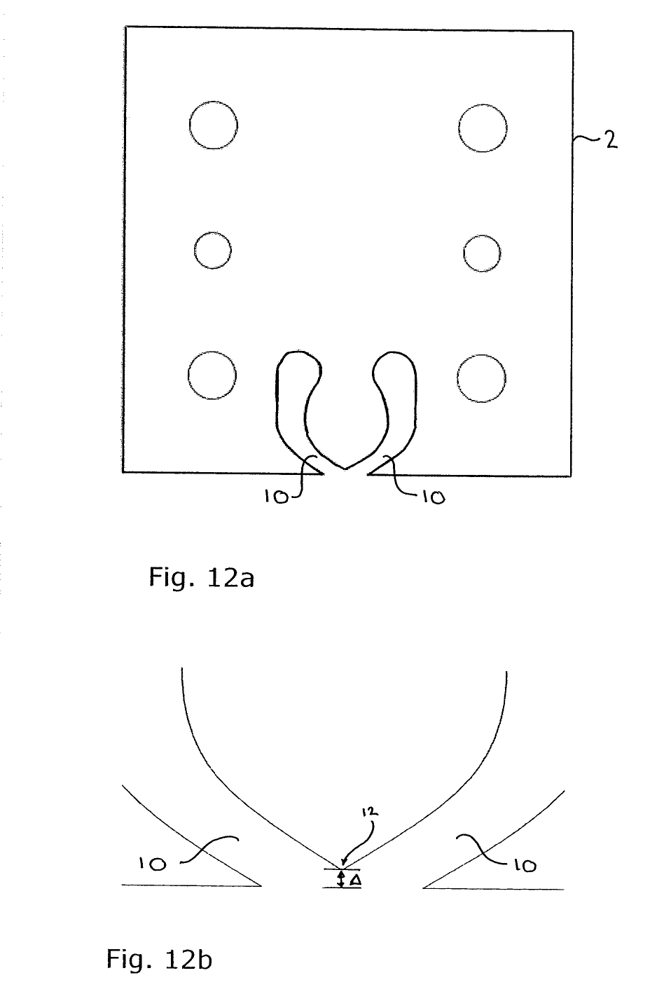

FIGS. 12a and 12b shows a schematic view of a channel spacer (2) similar to the one shown in FIG. 11. In this embodiment, the position where the two fluid streams impinge has been moved further towards the channel spacer and to such extend that the two fluid streams impinge at least partly inside the channel spacer (2). This is provided by arranging the flow channels (10) as two channels intersecting inside the end surface (11) of the nozzle as shown in FIGS. 12a and 12b. Thus, in this embodiment, the edge-shaped wall end (12) is located a distance Δ inside the channel spacer (2) measured from the level of end surface (20) of the channel spacer (2) or in general the level of end surface of the nozzle as these two surface preferably are at the same level in embodiments according to the present invention. As the impingement takes place at least partly inside the nozzle droplets leaving the nozzle will only has a velocity outwards relatively to the nozzle and back spray resulting in depositing of material at the end surface of the nozzle is found not to occur. The reason therefore is considered to be that droplets leaving the nozzle have only outwardly pointing velocities.

In these two embodiments the channels (10) are arranged as intersecting channels where the intersection is located at the end surface or inside the nozzle. Back spray is substantially avoided outside the nozzle as droplets leaving the nozzle substantially only have a velocity perpendicular to the end surface and out of the nozzle. If back spray should occur inside the nozzle, for instance in connection with the embodiment of FIG. 12, back sprayed droplets are sprayed into the fluid flowing through the channels 4a and 4b whereby depositing of back sprayed droplets is avoided.

The end surface as depicted herein is depicted as a straight plane. However, the end surface may have another shape such as tapered, rounded and the like. In connection with the embodiments of FIGS. 11 and 12, the intersection is in such cases located in the plane of the end surface and in the region of the outlets.

Although the embodiments of FIGS. 11 and 12 are shown as a channel spacer the principle of decreasing the distance 5 and/or letting the fluid stream impinge at least partly inside the nozzle may be applied to a nozzle in general with impinging fluid streams. For instance the channels (10) may be provided for instance in a nozzle block (where no channel spacer therefore is needed). Such an embodiment may comprise comprising an inlet for feeding fluid to the nozzle and one or more outlets being arranged so that fluid streams discharged from the one or more outlets impinge one another. A filter is preferably arranged in the flow lines leading fluid to the nozzle so as to filter the fluid before is reached the channels of the nozzle. The outlets are preferably arranged so that fluid streams discharged from two outlets impinge each other at an angle of between 30 and 1000 and the one or more of the outlets are preferably defined by the termination of a bore defining an outlet flow channel being in fluid communication with the inlet channel. The cross sectional area of each of the fluid streams discharged from the outlets is in the range of 0.003 to 0.15 mm², preferably in the range of 0.005 to 0.05 mm², such as in the range of 0.01 to 0.03 mm², preferably 0.02 mm².

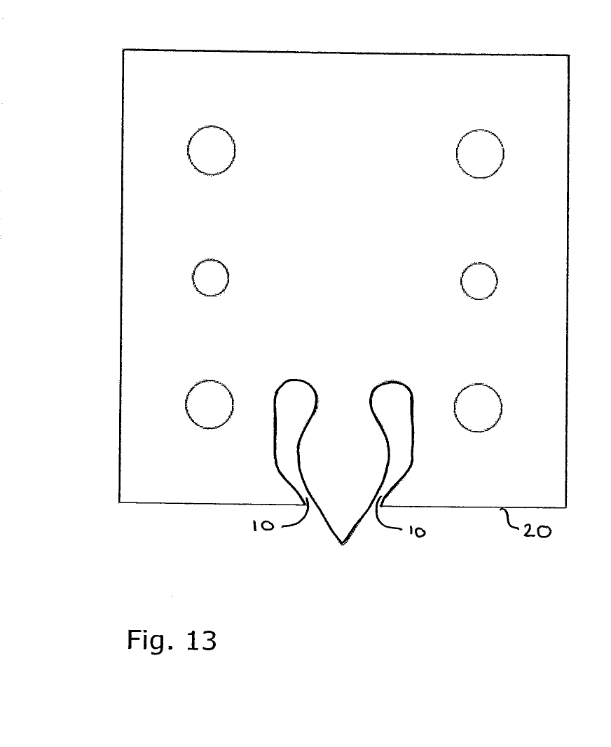

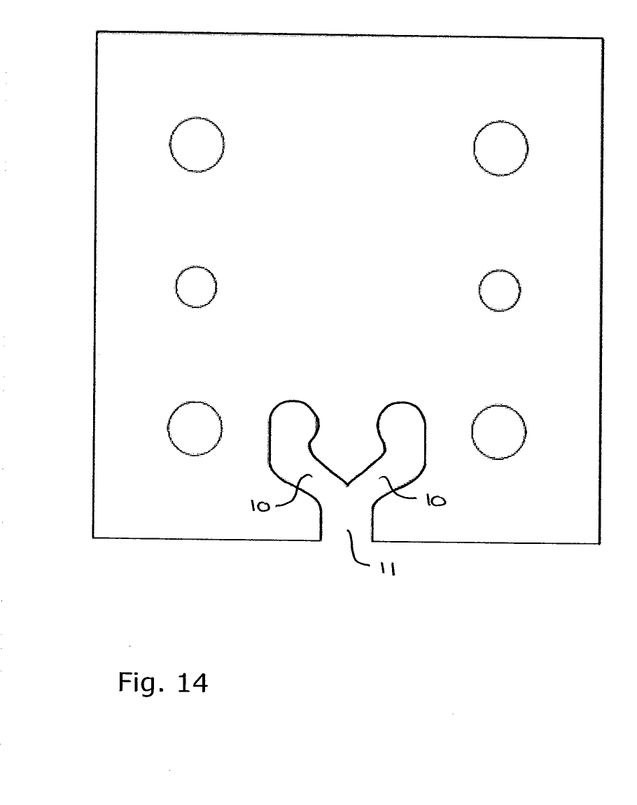

FIGS. 13 and 14 shows further embodiments of the channel spacer (2)—which embodiments may be applied to a nozzle in general—in which the channels (10) intersects outside the surface (20) of the nozzle (FIG. 13) or inside the nozzle (FIG. 14). In the embodiment shown in FIG. 14, a droplet outlet channel (11) is provided extending from the region where the two channels intersect to the surface (20) of the nozzle.

The above described figures are to be construed only as examples of possible embodiments of how the nozzle elements can be configured. Other combinations of the elements than shown in the attached figures are possible without changing the scope of the invention. One example is that the configurations of the channels (10) shown in connection with a channel spacer may be applied to the nozzle configuration shown in FIG. 1.

The present invention may find use in a number of applications in which atomization of a fluid is desired. One such application is for the addition of urea to the exhaust gasses of a combustion engine, such as a Diesel engine. A system embodying such an atomization preferably comprises a combustion engine preferably working according to the Diesel principle, a tank holding a liquid solution of urea (e.g. as known under the trade name AdBlue Din norm 70070) and a catalytic system as part of the exhaust system. The exhaust of the engine is connected to the catalytic system by an exhaust pipe typically having a diameter of 120 mm which is connected to the tank holding the liquid solution of urea via a metering and atomization system for metering out and atomize a quantity of urea corresponding to a given demand. Thus, the system further comprises a metering unit including an atomization nozzle for feeding the urea into the exhaust system so that it may react with the exhaust gasses for minimisation of the discharge of NOx gasses to the environment. When a nozzle according to the present invention is used to atomize the urea before it is added to the exhaust gasses, the nozzle may be comprised in a separate unit mounted after the metering unit at any position along the pipe leading the urea to the exhaust gas. Alternatively it may be integrated with the metering unit.

The unit is preferable placed so that the atomized urea is mixed with the exhaust gas directly after leaving the nozzle, and the nozzle is typically arranged so that the fluid exiting the nozzle is sprayed into the stream of exhaust gasses in a stream wise or in any other direction of the exhaust gasses which direction being not necessarily parallel with the stream wise direction of the exhaust gas such as perpendicular to the stream wise direction. The nozzle may be arranged in the centre of a pipe of an exhaust system of a combustion engine or gas turbine and/or in wall of the piping of the exhaust system. A plurality of nozzles may be circumferentially distributed along the wall of a pipe of an exhaust system of a combustion engine. The one or more nozzles may be placed at any position with respect to the pipe of an exhaust system within the scope of the invention.

The nozzle is typically arranged within the exhaust system in such a manner that an even distribution of atomized gas in the exhaust gasses is provided in order to assure that atomized fluid will be distributed evenly within the catalytic system. The nozzle may accordingly be arranged in the centre of the piping with its outlets facing in the stream wise direction of (but not necessarily parallel with) the exhaust gas.

In order to enhance even distribution of atomized fluid, a plurality of nozzles can be arranged in the exhaust system. Such a plurality of nozzles will preferably be arranged circumferentially and in some cases evenly distributed. However, the nozzles may also be distributed along the stream wise direction of the exhaust gases. The outlets of such nozzles are preferably arranged with the outlets facing in the stream wise direction of (but not necessarily parallel with) the exhaust gas.

It should be noted that a combination of nozzles being arranged circumferentially, in the stream wise direction, and/or one or more nozzles arranged in the centre of the piping is within the scope of the present invention.

1. A nozzle comprising:
a first member (1) having a surface A and a fluid inlet and a fluid outlet,
a second member (4) overlying the first member (1) and having a surface B, and
a channel spacer (2) positioned between the surface A and the surface B and in which channel spacer two or more converging and open channels being in fluid communication with the fluid outlet are formed for facilitating equal velocity and volume flow of each fluid stream at the channel openings at least when the nozzle is pressurised, said channels extending wholly through the thickness of the channel spacer.

2. A nozzle according to claim 1 further comprising a resilient member (3) positioned between said surfaces A and B of said first (1) and second (4) members.

3. A nozzle according to claim 2 further comprising a retention sheet member (5) positioned between the resilient member (3) and the second member (4).

4. A nozzle according to claim 1, wherein one or more indentations (35) is/are provided in the surface B of the second member (4) and/or in an indentation member (50).

5. A nozzle according to claim 1, wherein the at least two converging channels are arranged so that fluid streams flowing through the channels (10) impinge one another outside the nozzle.

6. A nozzle according to claim 1, wherein the at least two converging channels are arranged as channels intersecting inside the nozzle, at and/or above an end surface of the nozzle so that fluid streams flowing through the channels (10) impinge one another at and/or above the end surface or at least partly inside the nozzle.

7. A nozzle according to claim 6, wherein the channels are arranged so that fluid streams discharged from at least two channels impinge each other at an angle of between 30 and 100°.

8. A nozzle according to claim 1, wherein the cross sectional area of each of the fluid streams discharged from the channels is in the range of 0.003 to 0.15 mm², preferably in the range of 0.005 to 0.05 mm², such as in the range of 0.01 to 0.03 mm², preferably 0.02 mm.

9. A nozzle system for atomizing one or more fluids comprising two or more nozzles according to claim 1.

10. An exhaust system for a combustion engine, the system comprising a nozzle or nozzle system according to claim 1.

11. A method of atomizing fluid, preferably being liquefied urea, the method comprising feeding the fluid at a first pressure to a nozzle according to claim 1.

12. A method of atomizing fluid according to claim 11, further comprising the step of increasing the pressure of the fluid in case the flow resistance in the nozzle is increased as a result of deposits in the nozzle.
